(19) United States
(12) Patent Application Publication
(10) Pub. No.: US 2010/0024167 A1
(43) Pub. Date: Feb. 4, 2010

(54) HINGE AND COLLAPSIBLE DEVICE UTILIZING THE SAME

(75) Inventor: CHEN-WEI CHIANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/241,024

(22) Filed: Sep. 29, 2008

(30) Foreign Application Priority Data
Aug. 4, 2008 (CN) 200820301717.X

(51) Int. Cl. E05D 11/08; E05D 1/00

(52) U.S. Cl. 16/342

(57) ABSTRACT

A hinge includes a first element and a second element. The first element includes a shaft sleeve. The shaft sleeve defines a receiving space along an axial direction, and at lest one locating hole communicating with the receiving space in a circumference of the shaft sleeve. The second element includes an elastic shaft rotatable received in the receiving space, and a locating protrusion on a circumference of the shaft engagable in one of the at least one locating hole. A collapsible device utilizing the hinge is disclosed.

### CROSS-REFERENCE TO RELATED APPLICATION

This application is related to a co-pending U.S. patent application, Application No. [to be advised], Docket No. US22902, filed concurrently with the present application, entitled “HINGE AND COLLAPSIBLE DEVICE UTILIZING THE SAME”, which is assigned to the same assignee as that of the present application. The inventor of the co-pending application is Chen-Wei Chiang. The Specification and Drawings of the co-pending application is incorporated herein by reference.

### BACKGROUND

1. Field of the Invention

The invention relates to a hinge, and to a collapsible device utilizing the same.

2. Description of Related Art

A collapsible device, such as a notebook computer, or a clamshell mobile phone, generally includes a base, and a cover pivotably hinged on the base. The hinge generally includes a female hinge member mounted to the cover and a male hinge member mounted to the base. The female hinge member includes a shaft sleeve, and the male hinge member includes a split shaft rotatably received in the shaft sleeve. The split shaft includes two friction portions in frictional engagement with an inner wall of the shaft sleeve during rotation of the shaft relative to the shaft sleeve. However, this hinge is not durable because the friction portions are easily worn out. Moreover, once the cover is rotated to a determined angle relative to the base, the position of the cover is not easily identified by non-visual means.

### BRIEF DESCRIPTION OF THE DRAWINGS

FIG. 1 is an exploded, isometric view of an exemplary hinge.

FIG. 2 is similar to FIG. 1, but viewed from another perspective.

FIG. 3 is an assembled, isometric view of the hinge of FIG. 1.

FIG. 4 is an isometric view of a collapsible device utilizing the hinge of FIG. 3.

FIG. 5 is a cross-sectional view of the hinge of FIG. 3, showing the hinge being positioned at an expected position.

### DETAILED DESCRIPTION OF THE EMBODIMENTS

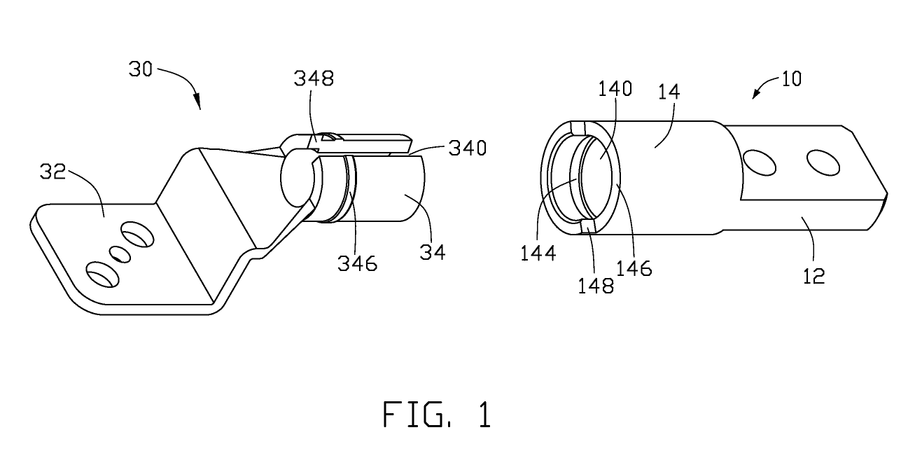

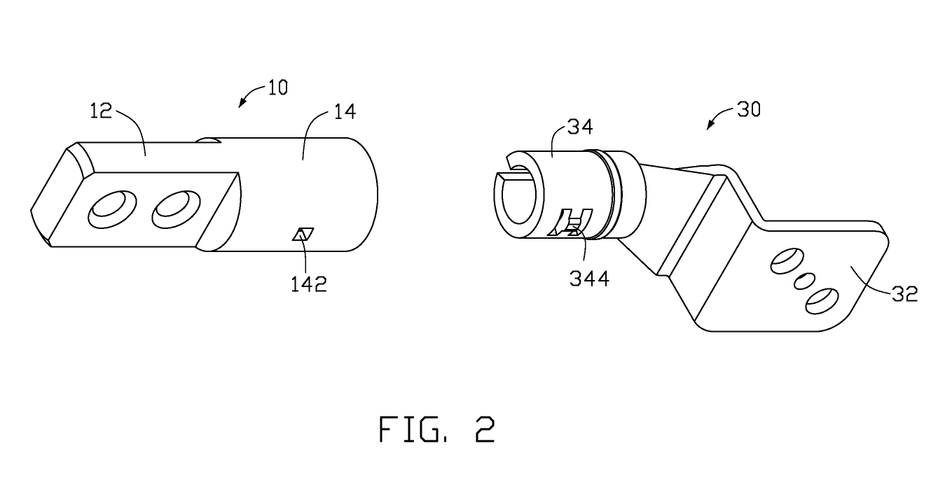

Referring to FIGS. 1 and 2, an exemplary hinge includes a first element 10 and a second element 30 capable of being pivotably mounted to the first element 10.

The first element 10 includes a flat connecting portion 12, and a shaft sleeve 14 extending from one end of the connecting portion 12.

A part of a distal end of the shaft sleeve 14 defines a depressed part 146, and a stop surface 148 facing the depressed part 146 is formed at an end of the depressed part 146. The shaft sleeve 14 defines a receiving space 140. An inner wall of the shaft sleeve 14 defines a circular groove 144 adjacent to the depressed part 146. The shaft sleeve 14 defines a locating hole 142 communicating with the receiving space 140.

The second element 30 includes a flat locating portion 32, and an elastic tube-shaped shaft 34 extending from a first end of the locating portion 32.

The shaft 34 defines a slot 340 in a circumference of the shaft 34 along an axial direction and extending from the first end through a second end of the shaft 34. The slot 340 is configured for deforming the shaft 34. A part of the shaft 34 protrudes out to form an elastic locating protrusion 344 in its circumference, opposite to the slot 340. A circular projecting part 346 protrudes out from the circumference of the shaft 34, adjacent to the first end. A block 348 facing the slot 340 protrudes out from the first end of the shaft 34.

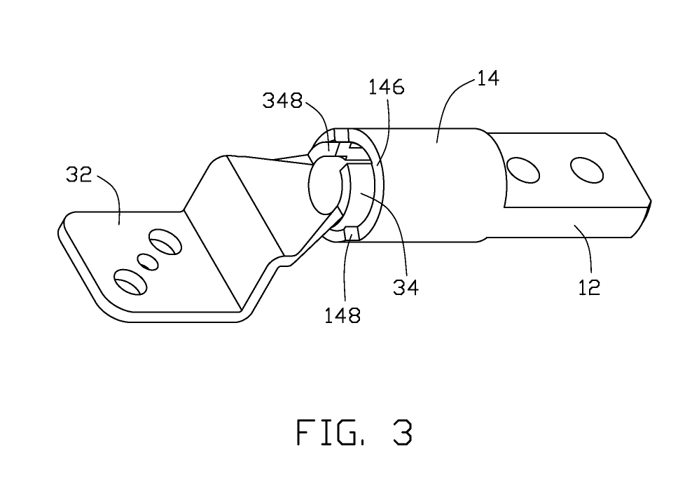

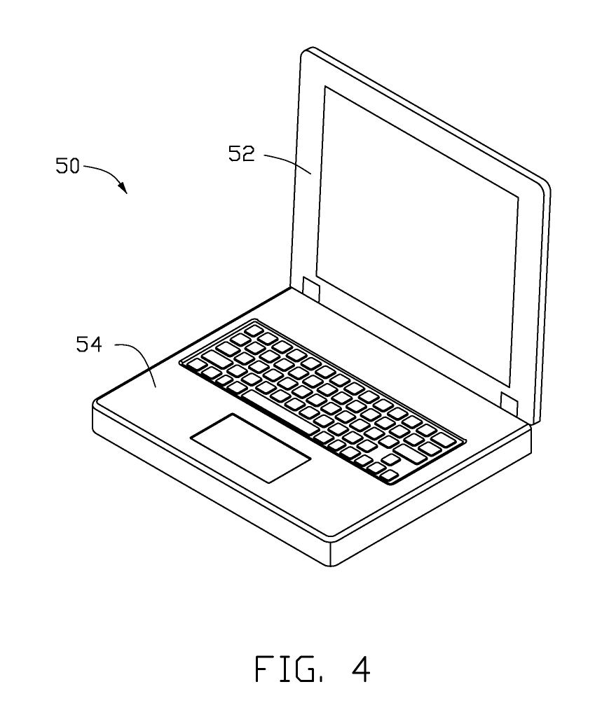

Referring to FIGS. 3 and 4, in assembly, the shaft 34 is compressed to enter the receiving space 140. After entering the receiving space 140, the shaft 34 is released to restore to elastically resist against the inner wall of the shaft sleeve 14. The projecting part 346 is engaged in the groove 144 for preventing the second element 30 from disengaging from the shaft sleeve 10, and the locating protrusion 344 is resisted against the inner wall of the shaft sleeve 14.

In use, the hinge can be utilized in a collapsible device 50, here for instance, in a notebook computer that includes a base 54 and a cover 52. The connecting portion 12 is fixed to one of the cover 52 and the base 54, and the locating portion 32 is fixed to the other one of the cover 52 and the base 54. The first element 10 is rotated relative to the second element 30 and the shaft 34 is rotated in the receiving space 140 when the cover 52 is rotated relative to the base 54. Restoration force of the shaft 34 makes the shaft 34 firmly abut against the inner wall of the shaft sleeve 14, resulting in enough friction between the shaft 34 and the shaft sleeve 14, so that the shaft 34 can be discretionally positioned relative to the shaft sleeve 14, and at the same time the cover 52 can be positioned at any angle relative to the base 54 within a predetermined range. The first element 10 cannot be rotated further when the block 348 resists against the stop surface 148. As a result, the cover 52 cannot be over-rotated.

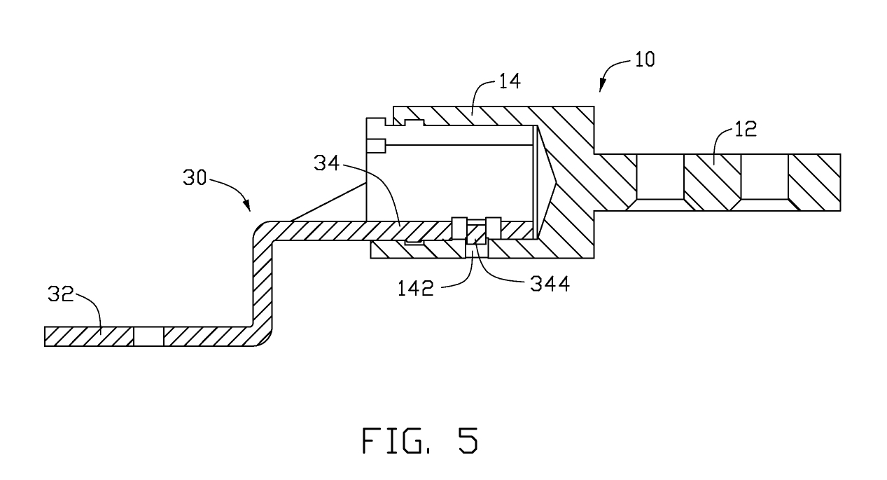

Referring to FIG. 5, once the locating protrusion 344 is moved to engage in the locating hole 142 during rotation of the cover 52 relative to the base 54, an obvious sensation can be felt by a user's hand so they can know the position of the cover 52 by touch. In other embodiments, the shaft sleeve 14 can define a plurality of locating holes 142 in a circumference of the shaft sleeve 14, arranged along a helical line, and a plurality of locating protrusions 344 arranged along a helical line protrude from the shaft 34. As a result, when the cover 52 is rotated relative to the base 54, any one of the plurality of locating protrusions 344 being engaged in a corresponding locating hole 142 will lead to an obvious sensation for the user. As a result, users can obtain orientation of the cover 52 relative to the base 54 by touch.

It is believed that the present embodiments and their advantages will be understood from the foregoing description, and it will be apparent that various changes may be made thereto without departing from the spirit and scope of the disclosure or sacrificing all of its material advantages, the example hereinbefore described merely being exemplary embodiments.

What is claimed is:

1. A hinge, comprising:
a first element comprising a shaft sleeve, the shaft sleeve defining a receiving space along an axial direction, and at lest one locating hole communicating with the receiving space in a circumference of the shaft sleeve; and
a second element comprising an elastic shaft elastically and pivotably received in the receiving space, and one elastic locating protrusion on a circumference of the shaft, the protrusion being engagable in one of the at least one locating hole.

2. The hinge of claim 1, wherein the shaft sleeve defines a groove in the inner wall of the shaft sleeve; the shaft defines a projecting part on the circumference of the shaft, the projecting part is engagable in the groove.

3. The hinge of claim 1, wherein the shaft is tube-shaped, and defines a slot in the circumference of the shaft along an axial direction and extending through opposite ends of the shaft.

4. The hinge of claim 1, wherein the shaft sleeve defines a depressed part, a stop surface faces the depressed part and positions at an end of the depressed part; the shaft defines a block protruding out from the shaft and capable of being resisted against the stop surface to stop the rotation of the shaft.

5. The hinge of claim 4, wherein the shaft is tube-shaped and defines a slot in the circumference of the shaft along an axial direction and extending through opposite ends of the shaft.

6. The hinge of claim 1, wherein the protrusion is protruded from the circumference of the shaft.

7. A collapsible device comprising:
a base;
a hinge comprising:
a first element comprising a shaft sleeve, the shaft sleeve defining a receiving space along an axial direction, and at lest one locating hole communicating with the receiving space in a circumference of the shaft sleeve; and
a second element comprising an elastic shaft elastically and pivotably received in the receiving space, and one elastic locating protrusion on a circumference of the shaft, the protrusion being engagable in one of the at least one locating hole; and
a cover pivotally mounted to the base via the hinge.

8. The collapsible device of claim 7, wherein the shaft sleeve defines a groove in the inner wall of the shaft sleeve; the shaft defines a projecting part on the circumference of the shaft, the projecting part is engagable in the groove.

9. The collapsible device of claim 7, wherein the shaft is tube-shaped and defines a slot in a circumference of the shaft along an axial direction and extending through opposite ends of the shaft.

10. The collapsible device of claim 7, wherein the shaft sleeve defines a depressed part, a stop surface faces the depressed part and positions at an end of the depressed part; the shaft defines a block protruding out from the shaft and capable of being resisted against the stop surface to stop the rotation of the shaft.

11. The collapsible device of claim 10, wherein the shaft is tube-shaped and defines a slot in a circumference of the shaft along an axial direction and extending through opposite ends of the shaft.

12. The collapsible device of claim 7, wherein the protrusion is protruded from the circumference of the shaft.
